(19) United States
(12) Patent Application Publication
(10) Pub. No.: US 2005/0246273 A1
(43) Pub. Date: Nov. 3, 2005

(54) Method of providing a buyer/seller website

(76) Inventor: Chris Farley, Whitewright, TX (US)

Correspondence Address: National IP Rights Center, LLC, Suite 400, 550 Township Line Road, Blue Bell, PA, 19422, US

(21) Appl. No.: 10/833,899

(22) Filed: Apr. 28, 2004

(51) Int. Cl. G06F 17/60

(52) U.S. Cl. 705/40; 705/1

(57) ABSTRACT

A method of providing online sales of properties by owners is disclosed. The method includes placing an advertisement for a property; providing a secure log in for a seller of property; providing a secure log in for a buyer of property; providing a database of properties for sale by the sellers; providing a plurality of seller functions; and providing a plurality of buyer functions.

### FIELD OF THE INVENTION

The present invention is directed to online computer systems. In particular, the present invention is specifically directed to online computer systems which can be used to promote online sale of properties by owners.

### BACKGROUND OF THE INVENTION

The Internet or World Wide Web is one of the most critical technological developments of the 1990's. The Internet has provided vast economic opportunities for numerous businesses and industries to vastly expand the number and quality of their services. One of the earliest and fastest emerging areas of Internet activity has been in providing rapid, up-to-the-minute business information. To date, a number of patents have issued on Internet related systems that cover a wide array of business information and electronic commerce (e-commerce) applications.

One of the earliest and largest uses of the Internet has been in the field of real estate and the online matching of properties with prospective buyers. The present invention is directed to the creation of a website which will promote realtors, as well as for sales by owner properties, choosing to sell without the benefit of a realtor. The website would be different in that it would be an advertising firm brining together for their mutual benefit two usually opposing parties. The realtors will be able to search the “for sale by owner” database and determine if that seller is offering a commission or not to a buyer's agent prior to showing it to a prospective client. In a way, it is a non-multiple listing service database for realtors. The agents can put in the criteria that he/she is looking for and have the results appear via an e-mail when a specified property becomes available. The non-mls database for realtors looking for properties for sale by owner that will offer a commission to buyer's agents and is auto-notified when a home meeting the requested criteria becomes available in the database. This is a concept which can be utilized for the site that will be in every state.

A number of U.S. patents have issued related to real estate offering websites. U.S. Patent Publication No. 2003/0130928 is directed to a means and method of creating and distributing real estate marketing sales packages utilized in the conduct of real estate business are described wherein an individual utilizing the computer programming developed may create, customize and distribute marketing materials through the use of the internet. The process utilized streamlines and enables the user of this system to create highly technical and comprehensive real estate marketing packages even if possessing only limited expertise in the fields of real estate and/or marketing. The method further offers the intended recipient of the real estate marketing package near instantaneous access and delivery of the real estate marketing package utilizing the Internet as the means of delivery without need for downloading the document.

U.S. Patent Publication No. 2003/010924 is directed to a method for remotely accessing a real estate listing database using a wireless phone or other wireless communication devices is provided in which a user first inputs the street number of a property which the user wishes to get information. The street number is then used to query an existing multiple listing service database. Subsequently, the user is provided with a list of street names on which properties with that particular street number are for sale. The user then selects a particular address in which the user is interested. After the selection is made, the user is provided with information pertaining to the selected property such as a description of the property for sale.

U.S. Pat. No. 6,236,977 to Verba is directed to a state-event engine manages behavior over time in response to events in deterministic fashion from user-supplied rules and policies for a set of dynamic objects. The campaign engine selectively generates and stores a campaign population, representing different types of marketing campaigns. A collection of dynamic object data stores maintains data on the corresponding marketing agent population, resource population, and listing population. A matching process orders members of the listing populations based on the target of at least two members of the campaign population such that a set of offers to buy and offers to sell the same resources is created. A prediction engines processes historical data to predict how campaigns can best match buyer to seller. Software agents negotiate on behalf of buyer and seller identify potential deals. The system is capable of being implemented using computer network and web-based technology.

U.S. Patent Publication No. 2002/0038280 is directed to providing a computer-implemented method and system for facilitating property transactions. This method and system includes profiling geographic areas and profiling a property seeker. The property seeker supplies seeker data including property characteristics desired by the property seeker, neighborhood features desired by the property seeker, and financial data describing the property seeker. The geographic areas are matched with the seeker data. The matched geographic areas and seeker data are presented. The method and system also provides for facilitating a property seeker's decision to market the property. The method and system can also provides for facilitating the exchange of information between the property supplier and the property seeker.

U.S. Pat. No. 6,636,803 is directed to a search and retrieval system includes a data terminal which displays icons representing properties in a given real estate market on a digital map. The icons are selectable so that, when selected, information derived from an MLS or other database is displayed in association with the map. In one embodiment, the data terminal is equipped with a GPS receiver and data-enabled mobile phone. The GPS receiver receives location data which is used by a processor to display an icon representing a current location of the terminal within the map. The data-enabled phone links the terminal to a remote server or database of property information, which may also be displayed when property icons are selected on the map. The property information may include media (e.g., bitmap) data that provide a visual depiction of the property icons selected. By integrating all of these digital sources of information on one terminal, the efficiency and accuracy of the property buying experience is significantly enhanced.

U.S. Patent Publication No. 2003/0163408 to Polston has an issue date of Aug. 28, 2003. This invention is directed to a computerized system and method for exchanging information between a buyer, a seller and lender. The present system and method permit a seller to enroll buyers and easily focus sales efforts at buyers who might not yet be ready to purchase. The system and method seamlessly integrate lenders, permitting lenders to participate earlier in the buying process. Also, the system and method help educate and develop buyers, and provide for more personalized contacts with the lender and the seller even during the earlier stages of the buying process. In one aspect, a computerized method for exchanging information between a buyer, seller and lender is disclosed. The computerized method shares buyer-specific information between the seller and the lender. The computerized system also generates item-information for the buyer based on the buyer-specific information. The computerized system also monitors buyer activity related to the item information. The seller and lender are able to focus their efforts based on this information. Also, the computerized system manages seller and lender contacts with the buyer.

### OBJECTS AND SUMMARY OF THE INVENTION

The rise in use of e-mail, facsimile transmission and video conferencing has minimized the need for prospective sellers and buyers to interact face to face.

It is therefore an object of the present invention to provide a system, accessible via a computer network, for providing means for potential sellers to find and access the skilled buyers.

It is a further object of the present invention to provide a system in which users and subscribers access the system via the Internet or World Wide Web and can be provided with a user interface which assists them in registering as a seller or buyer.

These and other objects of the present invention will become apparent from the detailed description and from the following summary, detailed description and claims.

In accordance with a first aspect of the present invention, a method of providing onsale by owner properties that can be accessed by a buyer or seller over the internet is provided.

In accordance with another aspect of the present invention, a novel method of providing online sales of properties by owners is provided. The method includes placing an advertisement for a property; providing a secure log in for a seller of property; providing a secure log in for a buyer of property; providing a database of properties for sale by the sellers; providing a plurality of seller functions; and providing a plurality of buyer functions.

In accordance with yet another aspect of the present invention, a novel method of geographical area licenses for a website network of advertisers who are buyers or sellers. The method includes providing a website where the advertiser can place an advertisement; and providing a licensee an exclusive license to a geographical area covered by the website.

### BRIEF DESCRIPTION OF THE DRAWINGS

The foregoing summary, as well as the following detailed description of a preferred embodiment of the present invention will be better understood when read with reference to the appended drawings, wherein:

FIG. 1 is a block diagram of the system of the present invention.

FIG. 2 is a block diagram of the web system in accordance with the present invention.

FIG. 3 is a block diagram of the database system in accordance with the present invention.

FIG. 4 is a flow diagram depicting a preferred method of listing a property by a seller in accordance with the present invention.

FIG. 5 is a flow diagram depicting a typical method for the seller to add or modify an advertisement for property.

### DETAILED DESCRIPTION OF THE PREFERRED EMBODIMENT

The present invention is directed to a system for placing over a communication network using, for example, personal computers and similar devices. While the present invention is being described in the context of a system using a personal computer, the manner of the end user device is not critical to the present invention. The present invention may be used with any system that connects to the Internet or uses other IP transport methods. The end user device can comprise any end user device which can connect to a network such as a wireless device, palm pilot, PDA, end user work station or hand-held device.

In a most preferred embodiment, the present invention is directed to a system for facilitating the hiring, screening and prequalification of buyers, both on a temporary and permanent basis.

Over the past fifteen (15) years, personal computers have become relatively powerful and inexpensive and have gained widespread use in a significant number of homes and businesses. With a modem, personal computers can communicate with other computers through communication networks and access many resources on the so-called “Information Super Highway”. Companies such as America Online, CompuServe, and Prodigy, which traditionally provided so-called “content” over proprietary networks, have begun to provide access by personal computer users to an expansive international network of computer networks known as the Internet.

As is well known by those skilled in the art, the World Wide Web is a graphical sub-network of the Internet. With common “Web Browser” software such as Mosaic, Netscape Navigator, or Microsoft Explorer, end users may easily access Internet information and services on the World Wide Web. A web browser handles the functions of locating and targeting information on the Internet and displaying the information provided by the Web Server. The World Wide Web utilizes technology called “Hyper-Text” to organize, search and present information on the Internet. Using a web browser, the end user can select a word (“Hyper-Text word”) from a view document and be linked to another document featuring information related to the word.

The present invention is broadly directed to a computer network for distributing information regarding requests for proposal from prospective clients and responses from attorneys in general, and patent or intellectual property attorneys and agents in particular. The present invention is designed, in one embodiment, to be utilized on the World Wide Web or Internet, although the present invention is equally applicable to other network environments. As noted above, the present invention is similarly related to user interfaces which are not computers such as palm pilots, wireless and cellular devices.

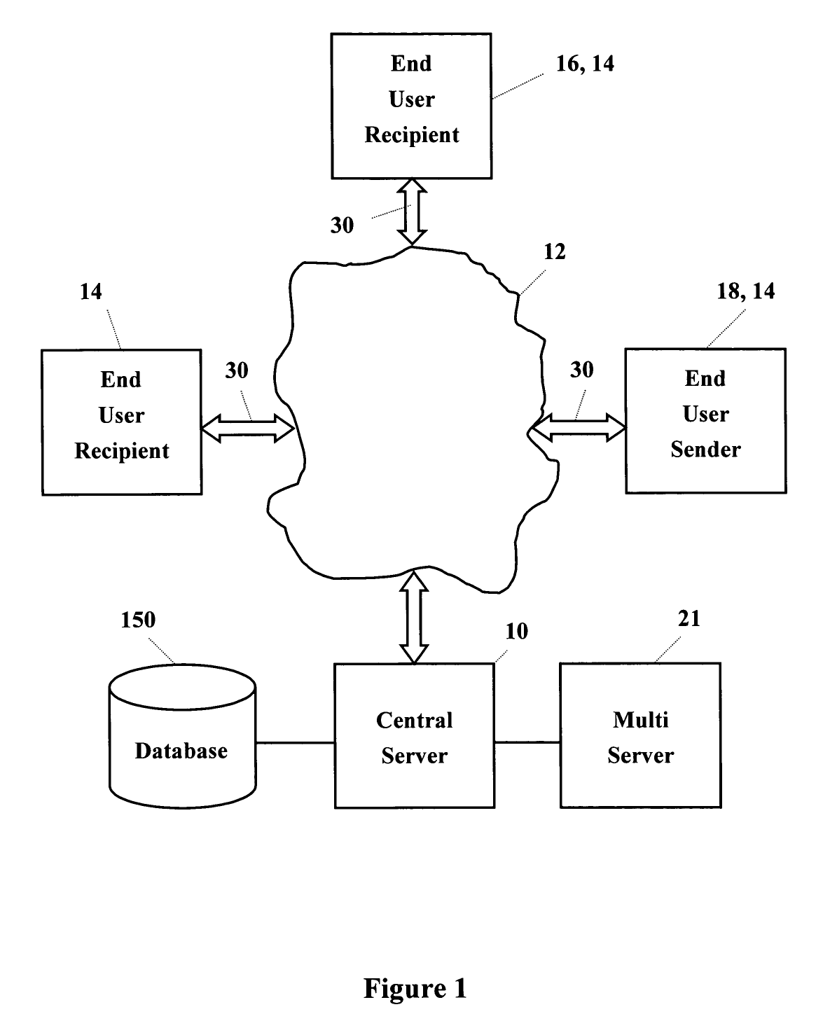

Referring now to the drawings wherein like reference numerals refer to the same components across the several views, and in particular to FIG. 1, a most preferred embodiment of the present invention is disclosed and shown. The most preferred embodiment comprises a central computer server 10 connected by a computer network 12 to remote end user stations 14. The central server connects to a database 150. In a preferred embodiment, end user stations 14 comprise a plurality of end users 6, 18. End users 16, 18 are defined herein as individuals linked to the system who will may comprise sellers or buyers Users 16, 18 are linked with the central computer server 10 via a transport medium 30. End users 16, 18 will typically comprise sellers and buyers who, in a most preferred embodiment, will be linked via a global computer network 12 such as the Internet or Worldwide web, but other embodiments including LANs, WANs and Intranets, fulfill the spirit and scope of the present invention.

The end user devices 16, 18 will typically comprise any device that connects to the system via the Internet or other IP transport methods and includes, but is not limited to, such devices as televisions, computers, hand-held devices, cellular phones, land based telephones, wireless electronic devices and any device which uses a transport medium 30. Non-limiting examples of a transport medium 30 applicable for use in the present invention comprise any backbone or link such as an ATM link, FDDI link, satellite link, cable, cellular, twisted pair, fiber optic, broadcast wireless network, the internet, the world wide web, local area network (LAN), wide area network (WAN), or any other kind of intranet environment such a standard Ethernet link. In such alternative cases, the clients will communicate with the system using protocols appropriate to the network to which that client is attached. All such embodiments and equivalents thereof are intended to be within the scope of the present invention.

Referring again to FIG. 1, the present invention may comprise a multi-server 21 environment which comprises a computer system in accordance with the present invention that allows the multiple end users 16, 18 to communicate with the system and system clients. Through communication link and transport medium 30, end users 16, 18 will receive data entries which must be correctly identified and confirmed and who are linked to the central server 12, preferably by a customizable interface to be described in greater detail below.

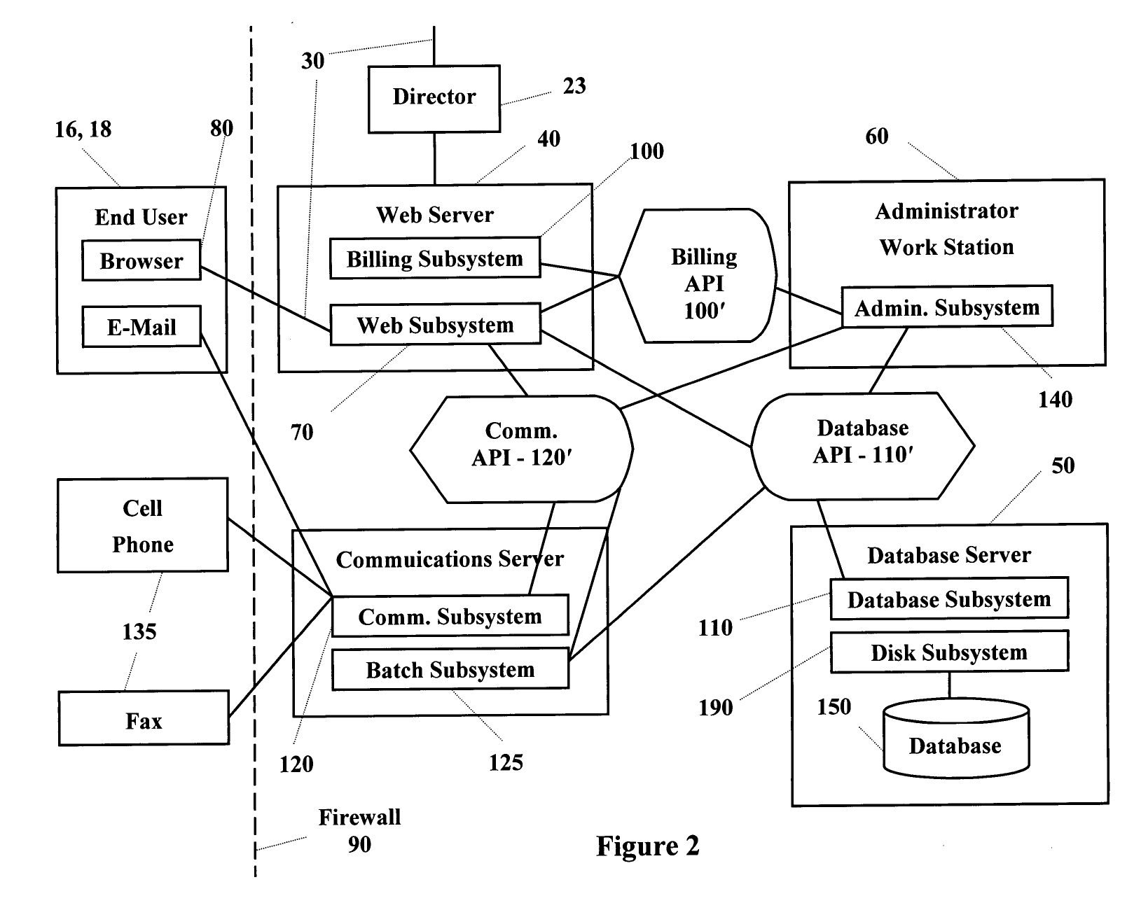

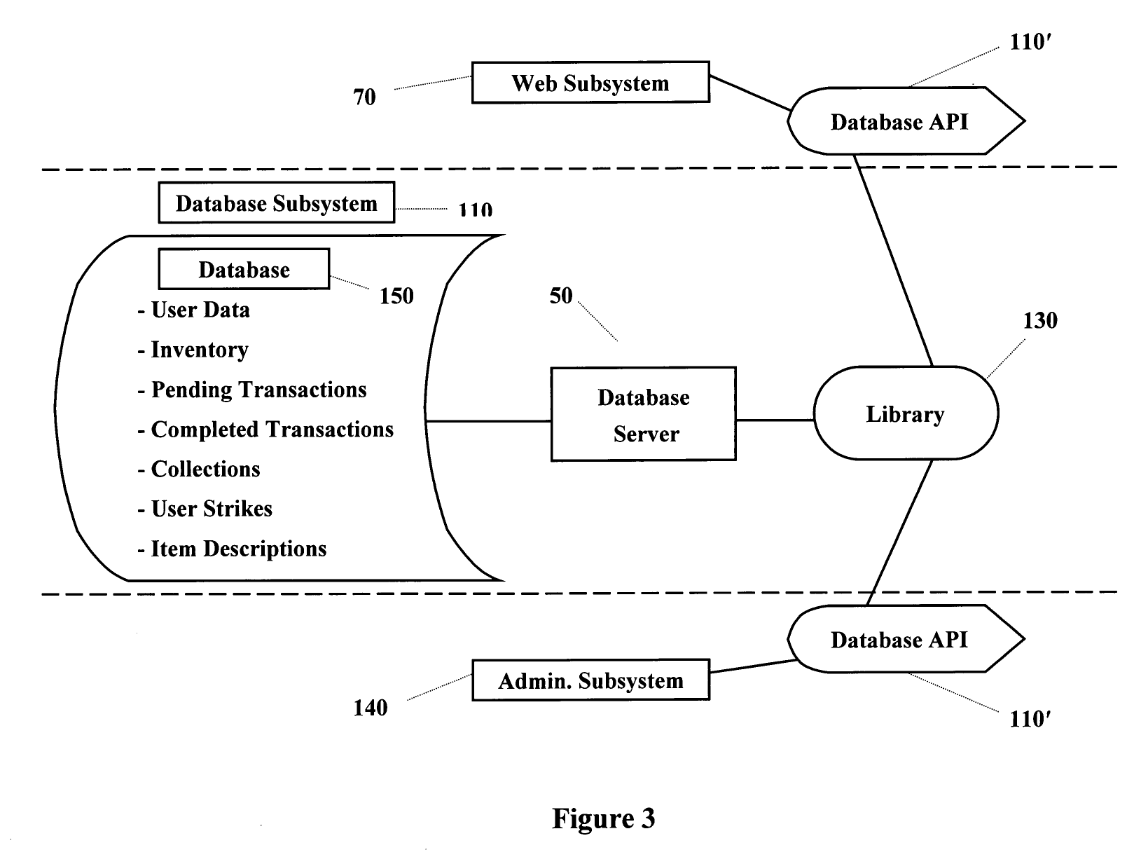

Referring to FIGS. 2 and 3, the central server and database systems of the present invention are now shown and described in greater detail. A local director 23 routes signals through the system to the various servers, to be described below, and to and through transport medium 30 to end users 16, 18. The system preferably includes two primary servers, a web server 40 and a database server 50 which may operate using such database platforms as SQL server or Oracle. Hence, in one embodiment the SQL server may run SQL server database management software from Microsoft Corporation. Alternatively, the server can further comprise an Oracle database server. The system further includes an administrative work station 60 or system which provides the administrative capabilities and monitoring for the system under the control of an administrative subsystem 140. The administrative work station 60 allows administrators or other operators to perform routine operations which affect the entire system. Such operations include, but are not limited to, administering the accounts of end user keyers 16, 18 monioring the traffic through the system, the tabulating of user balances and ratings, printing reports, the updating of end user keyers, the performing of backups and maintaining the programs that comprise the overall system.

A web subsystem 70 is responsible for all interactions with a web browser 80 in the end user devices 16, 18 and serves as the end user interface to the system. All interactions between the end user devices 16, 18 and the database subsystem occur through the web subsystem 70. Internet Information Server 200 (IIS) by Microsoft Corporation is an exemplary web server software system 70 in accordance with the present invention, although the present invention is in no way limited to this system. The expression of the user interface presented to end user 16, 18 in their client devices may be implemented as HTML or other high level computer language or technology, and may be displayed in a standard web browser. Typically, the interface will be presented as a website presentation such as WWW.JOBRIOT.COM.

All systems listed above are preferably communicated via an Ethernet 100 base T network and a switching hub. In addition, a second isolated network segment will preferably exist between the web server 40 and the external communications hardware (e.g. internet router). Such a system will keep external traffic isolated from the internal network, as well as provide a dedicated connection between the web server 40 and the Internet for maximum throughput. The systems will have an initial configuration of random access memory for the web server 40 and preferably at least 128 megabits for the database server 50, both having the capability to expand.

The web server 40 is the point of entry to the entire system. The system determines the identity of the users 16, 18 and makes appropriate decisions while serving webpages to the end users 16, 18. The web server 40 sends HTML or other high level computer language to the end user work stations 16, 18, validates passwords, sends logging and transaction information to the database server 50, and performs logical operations, thus behaving as a transactional server.

As noted above, in one embodiment, the server operating system may be a Windows NT server, a multi-platform operating system provided by Microsoft Corporation. The Sun Microsystems Solaris is an alternative embodiment. The server typically includes IIS, which is a completely integrated Internet application platform. IIS includes a high-performance web server, an application development environment, integrated full-text searching, multi-media streaming and site management tools. The security infrastructure is integrated within the server, thus enabling an easy-to-maintain and highly-secure web development and deployment environment.

The operators of the system may create, delete and update account information by utilizing the administrative subsystem 140 in administration work station 60. A billing subsystem 100 is used for crediting and debiting end user accounts. As will be discussed below, end users 16, 18 will typically receive remuneration of some manner for participating in the system including cash or other premiums.

Database 110, communication 120 and billing 100 subsystems thus execute essential services for the other parts of the system, and will therefore have well-defined application program interfaces (API) 110′, 120′, 100′, as is well recognized by those with skill in the art. The system will preferably be protected for the Internet by a “firewall” 90 which is a safety precaution, and important with respect to the present invention due to the sensitive and confidential nature of the information in the database. As will be discussed below, firewall 90 plays an important and critical role in the present invention because of the confidentiality of the data associated with some applications of the present invention.

In a preferred embodiment, the database subsystem 110 stores all pertinent information pertaining to user accounts, administrator accounts, payment and remuneration parameters, as well as general dynamic system information. All interactions with the database subsystem 110 are performed through a database API 110′ which may define the interface to a library of stored procedures 130. These are used to implement high-level database functions and to shield the details of the database implementation from the other subsystems. The database subsystem 110 is preferably implemented using database server 50.

The administration subsystem 140 provides an interface for operators and managers of the system to modify the database, print reports, view system data and log user comments and complaints. The administration subsystem 140 provides a collection of access forms, queries, reports and modules to implement the administration interface. Administrators typically will have the power within the system to force most actions. The administration subsystem 140 will interact with the communications, database and billing subsystems.

The communications subsystem 120 interfaced to a communications API 120′ will be used to email and contact end users 16, 18. End users 16, 18 may be notified by phone, fax, email or pager, or other communications devices which can be contacted by the system 135. End users 16, 18 will also have a password accessed section of a website where they can access information relevant to their activities and be provded with detailed reports.

Some portable telephones and pagers include email addresses and so may be contacted by the email system; other users have only phone numbers. Other interfaces may be utilized as the application so demands.

A batch subsystem 125 may periodically send out grouped notifications. It will access the database subsystem 110 to determine what notifications are required, and uses the communication subsystem 120 to make those notifications. A group notification may comprise a special premium offered to end user keyers 16, 18. The billing subsystem 100 will be used to verify and bill credit cards and communicate through the billing API 100′ to the administration subsystem 140, and potentially to an outside billing and verification service which could be used to perform the billing functions.

Referring to FIG. 3, the database server 50 which implements the database subsystem 110 of the present invention comprises a server that maintains all associated logging and transaction information for the system. Through the database 150 (which is backed up by a backup database for safety purposes), the database server 50 logs planner and provider setup and account creation information, stores buyer/seller data and changes made to that information, maintains user account information, maintains account balances, produces and prints reports, hosts backup operations and performs statistical calculations for the entire system.

The database server 50 is preferably a dual processor computer microprocessor. Each connection to the database 150 and its associated work may be handled by a separate thread within the database server 50 process space. It is anticipated that a dual processor machine is sufficient for the type and amount of transactions that it will be performing, however if it proves insufficient, the database can be “striped” to two or more machines to distribute the server load.

The disk subsystem 190 of the database server may comprise a vulnerable and crucial server element. Due to the mission critical design of the subsystem, it is preferable to utilize a Level 5 RAID. RAID is an alternative to standard SCSI hard disk drives. A RAID system provides automatic recovery from hard drive failures. Level 5 RAID systems provide the best balance between cost and level of data protection. A Level 5 RAID system uses multiple hard disk drives, on which the stored data is recorded redundantly using a scheme by which the data on the disk can be reconstructed if one of the disk drive units in the RAID fails. In the event of failure, the failed drive can be removed from the RAID system while it is still operating, and a replacement drive can be installed. The RAID system will regenerate the data and return itself to full protection capability. The data sorted on the disk subsystem remains available for normal processing, that is from the time the drive failures to the time the RAID system is returned to full protection capability. Other levels of RAID which are less costly do not offer this type of data availability and could translate into costly system downtime.

Statistical calculations will be performed by the database server 50, along with other types of report generation. Specifically, IIS can log directly to an Open Database Connectivity ((ODBC) standard data source. This makes the availability of the data collected by the database server about client activity on the system more readily available and easier to process into logical reports. Preferably the database server system is configured with a dual P6 CPU, 128 MB ECC, having sufficient ECC RAM, a graphics adapter capable of showing 1024×768 pixels with a depth of 8 bits, a 15 inch monitor, a PCI Fast/Wide SCSI-2 I/0 adapter, one PCI 100base T Ethernet adapter, a keyboard and a mouse, a 3.5 inch floppy drive, a CD ROM Drive, a disk drive, a 2 GB PCI Fast/Wide SCSI-2 hard disk drive, two 9 GB PCI Fast/Wide SCSI hard drives (Level 1) or an 8 GB RAID Subsystem (Level 5), and a 24 GB DAT SCSI (2MB per minute) tape back-up unit.

In one embodiment, there will be one operator workstation 60 used for administering the system. As the need for additional workstations arises, additional operator workstations can be added by adding additional computer systems, installing the administration software and connecting them to the LAN. Operator workstation machines preferably utilize a Windows operating environment manufactured by Microsoft Corporation.

Both the seller and buyer areas present the respective entities with static information pages such as promotional and explanatory material regarding the site. The site includes both a seller and a buyer log-in area. Both log-in areas lead to respective seller and buyer start pages.

The start pages, to be discussed in greater detail below, will comprise private areas of the site in which the sellers and buyers can store their respective data. This area includes a place where the seller can access the references regarding the buyer.

A user screen is provided which is accessible via the web browser of the client comprises an introductory text which will introduce the service to the end user. This page will preferably include FAQ (Frequently Asked Questions) and areas for both sellers and buyers to sign up. Registered sellers and buyers can log in.

A screen providing the terms of service to which the seller and buyer must agree in order to access the service is provided. The system includes an input screen where the end user inputs a user name and password. If the seller is a new user and has no user name and password, he is then taken to a screen that comprises a client intake form or screen. The intake screen comprises a plurality of user data fields in which the client inputs individual address and demographic information about himself/herself. As will be discussed below, it is advisable that the user input his state as a pull down screen.

Concurrently, with inputting the requisite buyer information, the buyer chooses his user name and password and may access further features of the system from his member Start Page. Like the buyer Start Page, a seller Start Page lists the number of accesses which have been posted.

After the buyer registers, the buyer is asked to place his name and password into the system. This will take the buyer to his Start Page. If the buyer has no password, he is taken to a screen where he agrees to the terms of use and then to a buyer registration form. The intake form will request the buyer to choose an email address and password and request information from the buyer.

The present invention is specifically directed to a dual-sided seller/buyer system. The seller or buyer can enter a secure website. The seller or buyer then can register by putting in specific information. Both the seller and buyer can input information concerning exactly what they are is looking for.

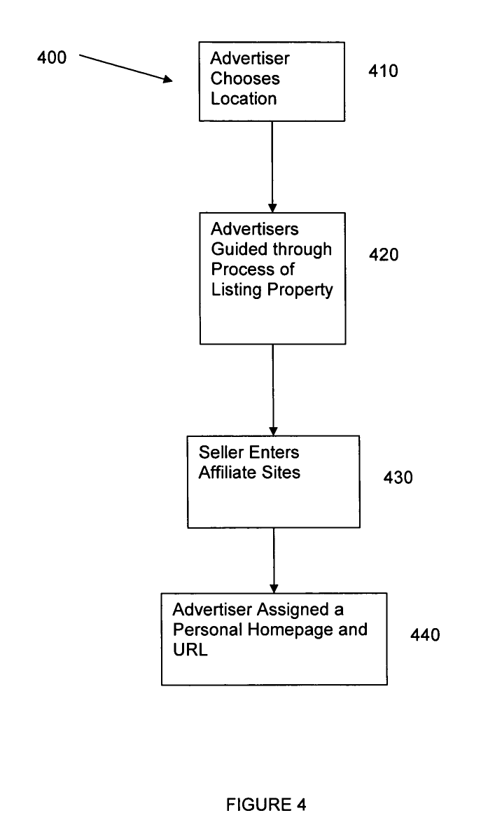

Referring now to FIG. 4, a preferred method 400 of providing an onsale by owner website is described. The first step 410 is for the seller or buyer, operating as advertiser, to choose the state, county, and city in which they want their ad to be offered. A listing wizard in step 420 guides advertisers through the process of listing their property from start to finish using a series of online forms. In a preferred embodiment of the present invention, the forms will contained detailed “how to” explanations as they progress through the listing and further through online payment.

In step 430, the seller will enter information into new listing input sheets to have their listing appear on other sites. Each advertiser is assigned a personal “home page”, “mini site”, and URL in step 440.

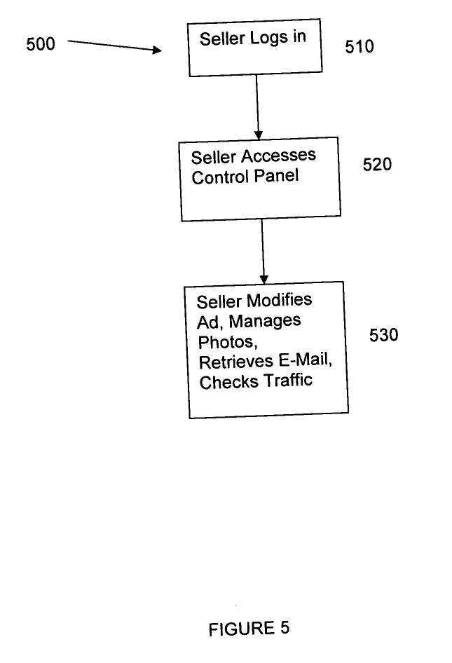

Referring now to FIG. 5, a flow diagram depicting seller operations 500 is illustrated. In step 510, the seller logs into the secure area using their username and password. In a preferred embodiment of the present invention, the password will be able to be retrieved online if the seller forgets it by offering the seller a “hint” to retrieve it. In step 520, the seller will access a control panel for their specific page. From the control panel, the seller can perform step 530, which is to modify or change their ads, add or delete photos, retrieve email inquiries or check traffic statistics to their page.

After the advertisement is paid for, the credit card is verified and an auto-notification notifies the advertiser that the transaction is complete, reminds them of their URL number, receipt number and general invoice information.

The buyer has access to a multitude of functions on the website as well. For example, the buyer may be provided with a “map this property” function. When the buyer clicks on this function, the buyer is given directions to the property. An additional function provided could be a “School Information” function, wherein the buyer is provided with school information for the surrounding area to the property, including school districts, private and parochial schools, and the like. A “Contact Owner” feature will allow a buyer to easily locate all the contact numbers, e-mail addresses, and the like the seller has elected to include in the advertisement.

Both sellers and buyers can communicate with each other via “blind” inquiries and responses if they wish to remain anonymous. Additionally, search functions are incorporated into the method to allow a buyer to locate a property by entering in detailed information about the property or by a “quick search” feature where the buyer can entire in a specific page URL to an advertisement that the buyer knows exists.

Another important function of the online sale of properties by owner method is that the method can act as an automatic cyber-agent for the buyer. That is, the buyer can enter certain criteria for a property, such as city, number of bedrooms, among other things, and the feature when activated will automatically search the seller database and notify the buyer if a property becomes available meeting the buyer's criteria. Additional functionality to this feature is that the seller database can be searched periodically, daily in a preferred embodiment, for properties that nearly fit the buyer's criteria, although not exactly. The feature will notify the buyer of the available property.

The advertiser can be sent email notices that their ad is about to expire. For example, a notification can be sent to the advertiser that his home for sale ad is going to expire 30 days prior to the expiration date of the advertisement. At that point, the advertiser can be given an option to renew the advertisement. In a preferred embodiment of the present invention, the advertising period is 6 months, however any period known to one of ordinary skill in the art may be used. If the advertiser does not renew the advertisement, then the advertisement will automatically be deleted on the last day of the scheduled run date.

The method will provide a “shopping cart”, wherein the buyers will have the option of adding properties to their shopping cart as they browse the listings. In this manner, the buyers can then compare properties that they've selected in their shopping cart. Furthermore, the buyers can print the properties they have selected. In a preferred embodiment of the present invention the buyers can print their selections in a “Flyer” format, however any method or format of printing the selections of the buyers known to one of ordinary skill in the art can be used. The comparison of properties can be done on a screen provided in which the buyer can compare properties based on a multitude of factors, such as price, location, bedrooms, and the like.

The seller has an additional offer feature, in which the sellers can list their homes with a price for auction or with a negotiator tool that allows them to have a blanked out acceptable price. The buyers can then enter a price for the property. If the price is too low then the buyer will get a message that they need to enter a higher offer. If the offer is in an acceptable amount, then the seller is notified and can respond to the inquiry.

In a preferred embodiment of the present invention, the method will be a method of providing geographical area licenses for a website.network of advertisers who are buyers or sellers. A website will be provided wherein the advertiser can place and advertisement for real or personal property. A licensee is granted an exclusive license to the website encompassing a particular geographical area, which is a county in a preferred embodiment of the present invention. The licensee, or county admin, receives revenue from the advertisements placed on the website for his geographical area.

The licensee is assigned a userid and password in which to access his website and to control the website. The licensee keeps whatever proceeds are generated from the ads that are placed on his website, and pays a monthly percentage to a licensor for the use of the website, including an administrative fee. The advertisements are placed online by the advertiser and are paid for via a credit card in a preferred embodiment of the present invention. Realtors/agents are provided with a separate logon and can advertise their multilisting services (MLS) as well. A commission can be provided by the advertiser for the realtor/agent and the realtor/agent can search the advertisement to determine which advertisements contain commissions.

In view of the foregoing disclosure, some advantages of the present invention can be seen. For example, a novel method of providing a buyer/seller website is disclosed. The website allows a licensee to have exclusive control over a geographical area where advertisers are placing advertisements.

The present invention is described with reference to the above-discussed preferred embodiments. It is to be recognized that other embodiments fulfill the spirit and scope of the present invention and that the true nature and scope of the present invention is to be determined with reference to the claims attached hereto. For example, in a preferred embodiment of the present invention, the geographical area is described as being a county, however, any reasonable geographical area known to one of ordinary skill in the art may be employed, such as municipality, county, state, country, continent, and the like.

1. A method of providing online sales of properties by owners, comprising the steps of:
placing an advertisement for a property;
providing a secure log in for a seller of property;
providing a secure log in for a buyer of property;
providing a database of properties for sale by the sellers;
providing a plurality of seller functions; and
providing a plurality of buyer functions.

2. The method of claim 1, wherein the step of providing a secure log in to the seller includes having the seller enter personal information to identify the seller.

3. The method of claim 2, wherein the step of providing a secure log in to the seller includes providing the seller with a username and password.

4. The method of claim 3, wherein the step of providing a secure log in to the seller includes allowing the seller to select the username and password.

5. The method of claim 1, wherein the step of providing a secure log in to the buyer includes having the buyer enter personal information to identify the buyer.

6. The method of claim 5, wherein the step of providing a secure log in to the buyer includes providing the buyer with a username and password.

7. The method of claim 6, wherein the step of providing a secure log in to the seller includes allowing the seller to select the username and password.

8. The method of claim 1, wherein the step of providing a plurality of buyer functions includes providing the buyer with a function to map the property and get directions to the property.

9. The method of claim 1, wherein the step of providing a plurality of buyer functions includes providing the buyer with a function to extract school information for the surrounding area to the property.

10. The method of claim 9, wherein the school information provided includes public districts, private schools, and parochial school district information.

11. The method of claim 1, wherein the step of providing a plurality of buyer functions includes providing the buyer with a function to contact the seller of the property.

12. The method of claim 1, wherein the step of providing a plurality of buyer functions includes providing the buyer with a shopping cart function which allows the buyer to add properties to the shopping cart for comparison with one another.

13. The method of claim 12, further providing the step of printing the properties added to the shopping cart.

14. The method of claim 13, wherein the step of printing includes printing the properties added to the shopping cart includes printing the properties added to the shopping cart in a Flyer format.

15. The method of claim 1, wherein the step of providing a plurality of buyer functions includes providing the buyer with cyber agent function, wherein the buyer can enter certain criteria for a property, and the cyber agent function will automatically search the database for properties that match the buyer's criteria.

16. The method of claim 15, wherein the criteria for the property include city and number of bedrooms.

17. The method of claim 15, wherein the database is searched periodically for properties that match the buyer's criteria.

18. The method of claim 1, wherein the step of providing a plurality of seller functions includes providing the seller with a control panel to allow the seller to add or modify the advertisement.

19. The method of claim 18, wherein the step of providing the seller with a control panel further includes allowing the seller to add photos, delete photos, retrieve email inquiries, or check traffic statistics to the seller's advertisement.

20. The method of claim 1, further comprising the step of notifying the seller when an advertisement placed by the seller is about to expire.

21. The method of claim 20, further comprising the step of renewing the advertisement place by the seller.

22. The method of claim 1, wherein the step of providing a plurality of seller functions includes providing the seller with the ability list their homes with a price for auction and to set an acceptable amount.

23. The method of claim 22, further comprising the step of allowing the buyer to place a bid on the home.

24. The method of claim 23, wherein the buyer is notified if the bid does not meet the acceptable amount.

25. The method of claim 23, wherein the seller is notified if the bid meets the acceptable amount.

26. The method of claim 1, wherein the step of providing a plurality of seller functions includes providing the seller with the ability to contact the buyer.

27. The method of claim 1, wherein the step of placing an advertisement includes the step of having the seller select the state, county, and city they want their ad to be placed.

28. The method of claim 27, further comprising the step of providing a listing wizard which will guide the seller from start to finish using online forms, to aid in listing the property in an advertisement.

29. A method of providing geographical area licenses for a website network of advertisers who are buyers or sellers, comprising the steps of:
providing a website where the advertiser can place an advertisement; and
providing a licensee an exclusive license to a geographical area covered by the website.

30. The method of claim 29, wherein the geographical area is a county.

31. The method of claim 29, wherein the licensee receives revenue from the advertisement placed by the advertiser on the website.

32. The method of claim 29, wherein the advertiser administers the advertiser's own advertisement on the website.

33. The method of claim 29, further comprising the step of providing each licensee with an individual userid and password, such that the licensee can control the website.

34. The method of claim 29, further comprising the step of providing a realtor/agent logon.

35. The method of claim 34, wherein the step of providing the realtor/agent logon includes allowing the realtor/agent to list the realtor's/agent's multilisting service.

36. The method of claim 34, wherein the step of providing the realtor/agent logon includes allowing the advertiser to provide a realtor/agent commission and the realtor/agent can search the advertisements for advertisements containing the realtor/agent commission.

37. The method of claim 29, wherein the advertisement is for the sale of property.

38. The method of claim 37, wherein the property is real property.

39. The method of claim 37, wherein the property is personal property.
